(19) United States
(12) Patent Application Publication
(10) Pub. No.: US 2005/0289326 A1
(43) Pub. Date: Dec. 29, 2005

(54) Packet processor with mild programmability

(75) Inventor: Chin-Tau Lea, Ma On Shan (HK)

Correspondence Address: ELIZABETH CHIEN-HALE, 40087 MISSION BLVD. BOX 367, FREMONT, CA, 94539, US

(73) Assignee: Hong Kong University of Science & Technology

(21) Appl. No.: 11/158,656

(22) Filed: Jun. 21, 2005

Related U.S. Application Data
(60) Provisional application No. 60/582,946, filed on Jun. 26, 2004.

(51) Int. Cl. G06F 15/00

(52) U.S. Cl. 712/218

(57) ABSTRACT

A reduced instruction set pipelined processor having an instruction fetch stage, an instruction decode stage, an executive stage and a write back stage and programmed with a single program which is structured to implement a function performed by a finite state machine. Only read after write data hazards exist in said processor, and these data hazards are eliminated by a forwarding unit in said executive stage which does an address comparison between the executive and write back stages and decides if a data hazard exists in accordance with predetermined logic. If a data hazard exists, suitable control signals are generated to control switching by multiplexers to supply operands to said ALU from said forwarding unit so as to eliminate said data hazards. Pipeline stall control hazards are reduced by inserting useful delay-slot instructions following at least some branch instructions in said program.

### CROSS REFERENCE TO THE RELATED PATENT APPLICATIONS

This application claims the benefit of U.S. Provisional Patent application 60/582,946, filed on Jun. 26, 2004, the disclosure of which are incorporated herein by reference.

### BACKGROUND OF THE INVENTION

Packet processing in the Internet has many levels of programmability requirements. Some tasks only require mild programmability and can't justify the use of a full-fledged packet processor. A finite state machine (FSM), on the other hand, has the benefit of performance, but cannot adapt to protocol changes. What is needed is something in between: fast, programmable, but not as complicated as a packet processor. A programmable state machine (PSM) is such an idea.

Consider the example in FIG. 1 which contains the major components in a generic prior art router/switch. A line card 10 terminates a transmission link 12 of different types of physical media. After the physical layer protocol is processed in the line card, the packet is passed to a packet processor (not separately shown) and an I/O port processor 16 for layer 2 and 3 processing. The processing includes IP table lookup and packet classification. Packets are then stored in a Traffic Manager (not shown, hereafter referred to as TM) that handles queuing (the TM is part of each line card 10, 18 etc.). Incoming packets are normally divided into cells in the TM for easy buffering. The cells are then sent to the switch fabric 20 for forwarding. When cells arrive from the switch, the TM will put them back into packets. So maintaining cell sequence in the switch fabric is important. Otherwise, the TM has to perform packet assembly.

Line cards are linked by a switch fabric. Several standard interfaces between the TM and the switch fabric have been proposed and one of them is the Common Switch Interface (CSIX) [CSIX specification, http://www.csix.org/csixl1.pdf].

Port processors 24 and 16 in the switch fabric buffer cells before sending them through the crossbar switch 22. The programmability issue also arises in the port processor. For example, some reserve bits are set aside in the CSIX header and different vendors may use them for different purposes. This type of programmability can never justify the use of a full-fledged packet processor. What we need is a design that is as simple as a FSM, but has a mild programmability.

### SUMMARY OF THE INVENTION

The Programmable State Machine (PSM) in FIG. 2 is such an idea. In this patent, we propose a Programmable State Machine (PSM) architecture that performs as fast as a Finite State Machine (FSM), but which can be easily programmed. The PSM is simple like an FSM because it only needs to run one program, that program being a program to emulate the function of an FSM to do, for example, packet processing. No need for all the complexity of expensive packet processors that need to be able to run many programs. The PSM is more flexible than an FSM however because when a protocol changes, all that is necessary in a PSM is that the program be re-written whereas an FSM needs to be scrapped and a new one designed.

The architecture of the PSM is based on a simplified RISC architecture. Our proposed PSM adopts a pipelined architecture. Because the PSM only needs to do one mission and run one program, it can be much simpler in its hardware design than a packet processor. Further, hazard control of the PSM pipelined architecture is much simpler since only one program needs to be executed and hazards are predictable and many pipelined architecture hazards for general purpose pipelined processors do not exist in the PSM. By taking advantage of the characteristics of a PSM's main function—FSM emulation—we are able to remove the main complexities associated with hazards control existing in a conventional RISC pipelined processor. The PSM architecture has a low complexity and can be used to replace any FSM that may require programmability.

### BRIEF DESCRIPTION OF THE DRAWINGS

FIG. 1 is block diagram of a prior art router/switch.

FIG. 2 is a block diagram of a system including a programmable state machine according to the teachings of the invention.

FIG. 3 is a block diagram of a stripped-down RISC machine to implement the programmable state machine of the invention.

FIG. 4(A) is a diagram of the data structure of register type instructions.

FIG. 4(B) is a diagram of the data structure of immediate type instructions.

FIG. 4(C) is a diagram of the data structure of branch type instructions.

FIG. 5 is a diagram of the different sets of registers in the PSM and their general function.

FIG. 6 shows the tasks in header parsing and an FSM block diagram to do this task.

FIG. 7 shows the CSIX header in which two bytes are used for based header and four bytes are used for extension header.

FIG. 8 is a diagram of the prior art interface of the FSM.

FIG. 9 is a flow chart of the prior art header parsing process carried out by a prior art FSM.

FIG. 10(A) is a table of input/output register definitions, and FIG. 10(B) is a command word register definition.

FIG. 11 is the program to control the PSM to do header parsing after a first phase of development.

FIG. 12 is the optimized program to control the PSM to do header parsing after optimization of the code of FIG. 11.

### DETAILED DESCRIPTION OF THE PREFERRED EMBODIMENT

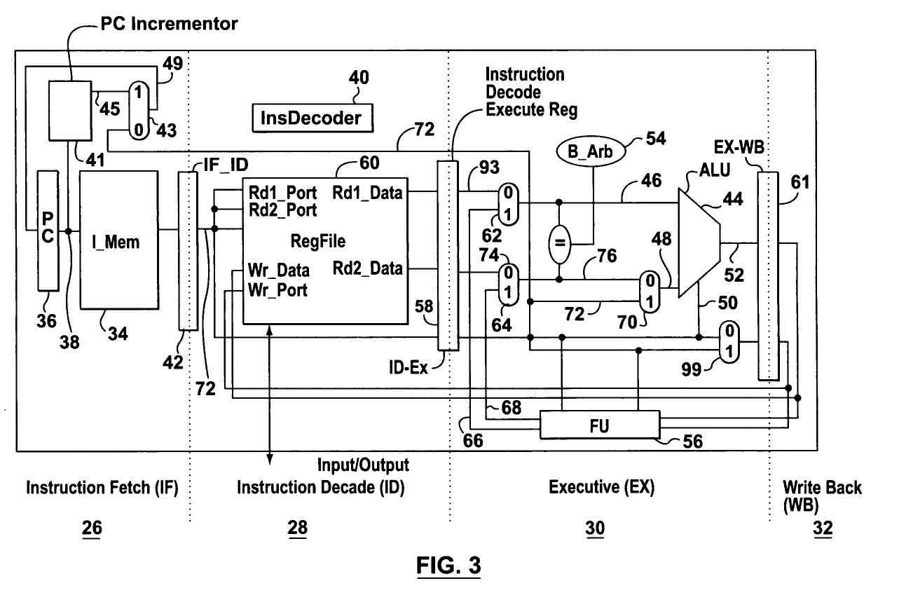

The teachings of the invention for a programmable state machine (PSM) are implemented via a stripped-down Reduced Instruction Set Computer (RISC) type machine as shown in FIG. 3. It has only four stages—Instruction Fetch (IF) 26, Instruction Decode (ID) 28, Executive (EX) 30, and Write Back (WB) 32. The Memory (MEM) stage of conventional pipelined RISC computer has been removed, and hazard control is simplified in the PSM of FIG. 3.

The main blocks are the following.
1. Instruction Memory(I_Mem) 34: this circuit stores instructions. In one embodiment, it only holds 128 instructions.
2. Program Counter(PC) register 36: this circuit stores a pointer to the next instruction to be executed and supplies that pointer as an address on bus 38 to the instruction memory 34. The address of the next instruction is incremented by program counter incrementer 41 which outputs the incremented address on line 45 to one input of a two input, single output multiplexer 43. The other input 72 to the multiplexer 43 is supplied by the executive circuit 30 so that immediate inputs can be supplied to the program counter 36 to implement jumps in the program from transfer statements, etc. Immediate values come from immediate instructions which store immediate values in register 42 for output on line 72. This line is coupled to various circuits to supply immediate values to them. The output 49 of the multiplexer 43 is input to the program counter register 36.
3. Instruction Decoder(ID) 40: This circuit decodes the instruction stored in register 42 output by the instruction memory 34 in response to the address on bus 38 and generates control signals.

4. Arithmetic and Logic Unit (ALU) 44: This circuit performs arithmetic and logical operations on operands supplied to its inputs 46 and 48 in accordance with an operation code supplied on bus 50. The results are output on bus 52. Each of its two inputs receives an operand stored in a register in the register file 60. Each input 46 and 48 is the output of a multiplexer so that multiple sources can be coupled to each input of the ALU. The operand supplied to input 46 is controlled by multiplexer (hereafter MUX) 62. The operand supplied to input 48 is controlled by MUX 64. The functions of MUXs 62 and 64 is to select as operands for the ALU the content of the first and second source registers either forwarded values from the FU 56 or values from the register file 60. The input on line 74 to MUX 64 is a register value sent from the previous stage. The input on line 68 is sent by the Forwarding Unit 56. If the switching control signal (not shown) to MUX 64 is true, then the MUX selects the data on line 68 for output on line 76. If the switching control signal to MUX 64 (not shown) is false, the value decoded from the previous stage register file on line 74 is coupled to line 76. Likewise, MUX 62 selects the value from the previous stage register file 58 on line 93 when its switching control signal (not shown) is false and selects the forwarded value from FU 56 on line 66 when its switching control signal is true. Switching of each of multiplexers 62 and 64 is controlled by switching control signals generated by the FU 56 such that if the FU 56 decides forwarding is required to prevent a hazard, each multiplexer 62 and 64 selects as the operand to supply to the ALU the operands supplied by the FU on lines 66 and 68. The switching control signals state is determined by the following logic:

```
if ( (WB.WrReg==1) and (WB.DestReg==EX.SrcReg1)) then
    or DataForward_1=1
if ( (WB.WrReg==1) and (WB.DestReg==EX.SrcReg2)) then
    or DataForward_2=1
```

A third multiplexer 70 is used to select between the output of multiplexer 64 on line 76 (with a register value) or an immediate value on line 72 supplied from register 42 upon decoding of a an arithmetic or logic instruction bearing an immediate number therein. For example the second input to the ALU can be an immediate input, such as:

(rt)=(rs) OP Imm
5.Branch Arbitration Unit(B_Arb) 54: When a branch instruction is met, the instruction decoder 40 decides the type of the branch. Based on this information and the comparison results given by ALU, B_Arb 54 decides if the branch will be taken or not. For example, consider the command “beq” (actually these commands should be named beq and beqi). If the test condition is met, then the branch arbitration unit 54 replaces the Program Counter 36 contents with the new label indicated by the register content (in the case of a beq instruction), or the label contained in the current branch instruction (in the case of a beqi instruction). The branch arbitration unit accomplishes this by controlling the multiplexer 43 after the incrementer (PC_inc) to select the data on bus 47 and couple it to bus 49.

6. Forwarding Unit( FU) 56 Bypass logic: With this block, the result of the first instruction execution can be used by the second instruction immediately before it is actually written to register files. To prevent R/W hazard, the PSM checks if the current instruction will change the value of some register. If so, the PSM checks if the register is used by the n ext instruction. If true, the PSM turns on the FU 56 and replaces the register values already retrieved for the next instruction. This is explained further below. More specifically:

```
if (WB.WrReg==1) then
    if ((WB.DestReg==EX.SrcReg1) or
        (WB.DestReg==EX.SrcReg2) )
```

Then turn on the FU and send replace the register values (Source) with the new value. In the notation WB.DestReg==EX.SrcReg1, the DestReg is the destination register of the current instruction (at the WB stage), and SRCReg1 is the source register of the next instruction (at the EX or Executive stage). The source and destination registers are defined below in the descriptions of the instructions in the instruction set. The WB.WrReg in the notation above refers to the WrReg control signal in the Write Back (WB) stage. The WrReg control signal is generated by the instruction decode circuit 40. The syntax “if (WB.WrReg==1) then . . .” means that if the WrReg control signal is true, the WB stage needs to write back the calculated result into the WB stage destination register. The multiplexer 70 has one input coupled to receive the output selected by MUX 64. Its other input 72 is coupled to receive a constant value supplied by the instruction itself for operations involving manipulation of constants. The MUX 70 selects either the output of MUX 64 or the constant (immediate value) on line 72 to supply to input 48 of the ALU. Multiplexer 99 between ALU and WB is to select the destination register address. Recall that an instruction can involve three different registers: rs, rt, rd. An example involving register manipulate instructions is

“add DestReg, SrcReg1, SrcReg2”, we have
(rd) = (rs) OP (rt),

Here rt is the register address for the 2nd operand and rs is the register address for the 1ₛₜ operand, and rd is the destination register address.

For instruction containing immediate value, such as

“addi DestReg, SrcReg, Imm” we have
(rt) = (rs) OP Imm

Here rt is the destination register address, rs is the source register address for the first operand and Imm is the immediate value contained in the instruction and input to MUX 70 on line 72.

In instruction format definition, “rt” segment is the bit [20:16] in instruction format “rd” segment is the bit [15:11] in instruction format, so to get the correct destination register address, we need another MUX. That is MUX 99 between the ALU 44 and WB write back register 60.
7. IF_ID 42, ID_EX 58 and EX_WB 61 Pipeline registers: These registers store temporary values and control signals of each pipeline stage. When the NOP (no operation) instruction in the instruction set is executed, the values in these registers remain unchanged for one cycle. The register file 60 is a collection of registers which store data. Any register mentioned herein which is not specifically shown on FIG. 3 is in the register file 60.

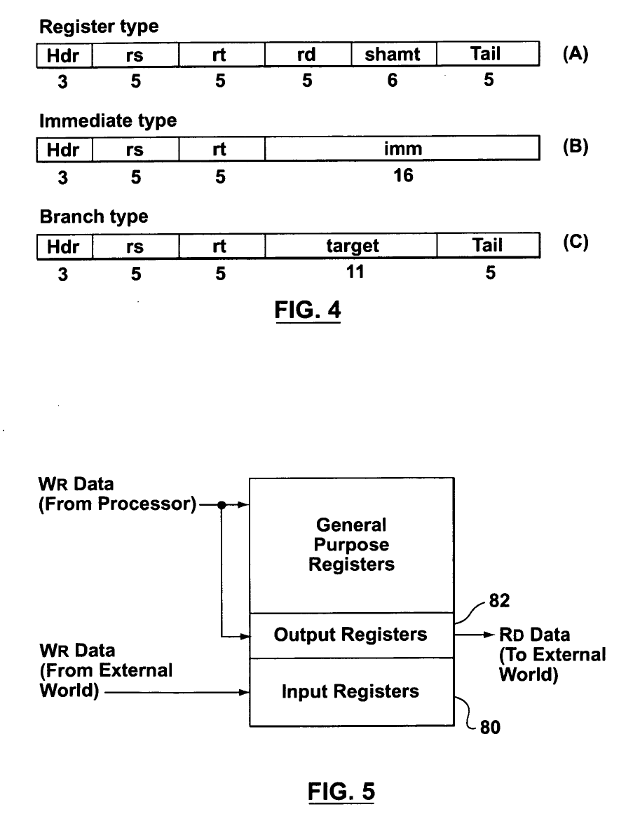

With respect to the timing of transfer of data between stages of the pipeline, no special clock is needed and one clock is supplied to all stages of the PSM pipeline. In register mode (when executing instructions to operate on data in registers and store the result in a register), the MIPS convention is used. Generally, instructions perform the following operations involving registers: (rd)=(rs)OP(rt) where (referring to FIG. 4(A)):

(rd) is the register destination which stores the result of the operation;

(rs) is the first register source;

(rt) is the second register source; and shamt is the shift amount for shift instructions.

The Main Difference Betweem the Programmable State Machine and Conventional Pipelined Processors

The main differences between our PSM and a conventional pipelined processor such as is described in John L. Hennessy, David A. Patterson “Computer organization and design: the hardware/software interface” San Francisco: Morgan Kaufmann Publishers, 1997.

1. The Programmable State Machine (PSM) of FIG. 3 does not have the MEM stage of a conventional pipelined processor and the FU can be implemented with less than 100 gates. This elimination of the memory stage can be done because a conventional RISC machine is a general purpose processor and must uses memory to store data and instruction. Thus the last stage of a pipeline is usually to store the result of the execution back into the memory. In contrast, the RISC architecture Programmable State Machine of FIG. 3 is only for finite state machine (FSM) emulation and it interfaces with the outside world through registers in real time. There are no results to store in the PSM. The instructions for finite state machine emulation are stored in the I_MEM. But the content of the instruction memory will not change once the FSM is determined.

2. The task for PSM is FSM emulation. I_Mem (instruction memory) rarely needs more than 128 entries. This allows for a fast instruction fetch implementation.

3. No interrupt instructions are needed in the PSM of FIG. 3.

4. Hazard control in the PSM is simplified by the predictability of the task for the PSM--FSM emulation. The Boolean expression for implementing hazard control is given below.

5. Registers of the PSM are divided into two groups: the internal registers and the input/output registers. The inpuvoutput registers interface with other FSMs/PSMs. Generating control signals to the outside world are done by writing the registers. The internal registers are used as general-purpose registers.

The Instruction Set

To demonstrate the function of the architecture of the PSM of the invention, consider the following instruction set which are instructions the PSM can execute. Note that the optimal selection of the instruction set depends on the type of task for which the PSM is intended.

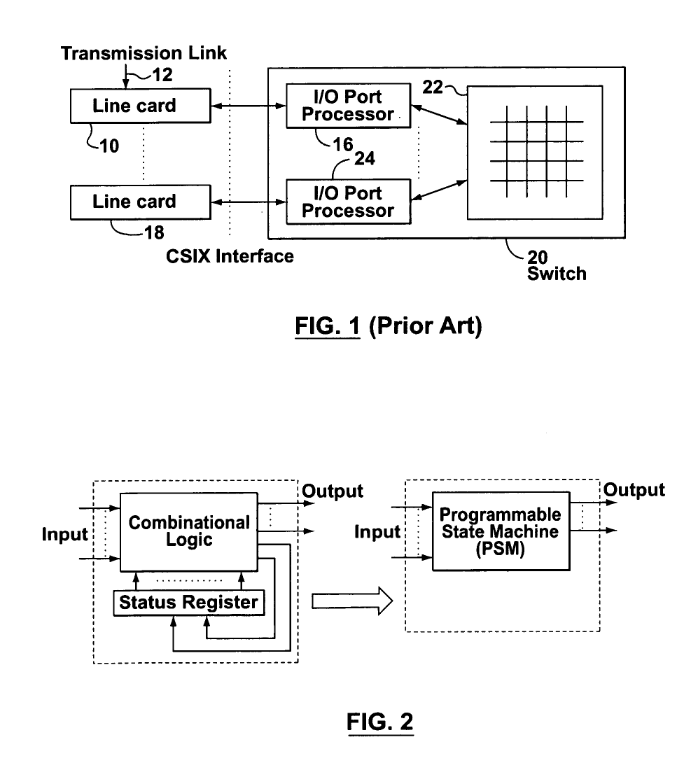

The task for a PSM according to the teachings of the invention is packet processing in the Port Processor of FIG. 1. The PSM needs only 18 instructions to perform this packet processing, and all instructions have a fixed length: 29 bits. If the PSM is used for other applications, the instruction set can be extended. These instructions are classified into three categories based on their format:

Register type: See FIG. 4(A) for instruction data structure.

Immediate type: See FIG. 4(B) for instruction data structure.

Branch type: See FIG. 4(C) for instruction data structure.

Each instruction has a header and tail segment which is used to decode the instruction. Decoding the instructions creates the control signals which control the various circuits and multiplexers in the circuit of FIG. 3.

When these instructions are classified in terms of their usage, they are:

Arithmetic and Logic Instructions

| | | |
|---|---|---|
| add | DestReg, SrcReg1, | ;Addition |
| | SrcReg2 | |
| addi | DestReg, SrcReg,Imm | ;Addition with immediate number |
| and | DestReg, SrcReg1, | ;Logical AND |
| | SrcReg2 | |
| andi | DestReg, SrcReg,Imm | ;Logical AND with immediate |
| | | number |
| or | DestReg, SrcReg1, | ;Logical OR |
| | SrcReg2 | |
| ori | DestReg, SrcReg,Imm | ;Logical OR with immediate number |
| sll | DestReg, SrcReg,Shamt | ;Shift logic left |
| srl | DestReg, SrcReg,Shamt | ;Shift logic right |
| xor | DestReg, SrcReg1, | ;Logical XOR |
| | SrcReg2 | |
| xori | DestReg, SrcReg,Imm | ;Logical XOR with immediate |
| | | number |

Constant manipulating Instruction

| | | |
|---|---|---|
| li | DestReg, imm | ;Load immediate number |

Branch Instructions

| | | |
|---|---|---|
| beqi | Reg1, Reg2, LABLE | ;Jump to Label if (Reg1==Reg2) - |
| | | immediate |
| beq | Reg1, Reg2, TargetReg | ;Jump to addr given by TargetReg if |
| | | (Reg1==Reg2) |
| bgtei | Reg1, Reg2, LABEL | ;Jump to Label if (Reg1>=Reg2) - |
| | | immediate |
| bgte | Reg1, Reg2, TargetReg | ;Jump to addr given by TargetReg if |
| | | (Reg1>=Reg2) |
| bgti | Reg1, Reg2, LABLE | ;Jump to Label if (Reg1>Reg2) - |
| | | immediate |
| bgt | Reg1, Reg2, TargetReg | ;Jump to addr given by TargetReg if |
| | | (Reg1>Reg2) |

No Operation Instruction
NOP; do nothing operation

The registers defined above are located in the register file 60.
Data and Control Hazard Removal

In a general-purpose RISK processor, hazard removal has a high complexity. But this is not the case with a PSM according to the teachings of the invention. This is because the processor is designed to emulate a Finite State Machine (FSM) and to perform a fixed function of packet processing. This limited role substantially reduces the possible hazards that must be eliminated or minimized.

There are two types of hazards in every pipeline processor: data and control hazards.

Data Hazards

Data hazards are checked in the forward unit. Consider two instructions N and M, with N occurring before M. The possible data hazards are:
RAW (read after write)-M tries to read a source before N writes it, so M incorrectly gets the old value.

To check this type of hazard, two register-address comparisons are performed between stages EX and WB as below.

```
if (WB.WrReg==1) then
    if ((WB.DestReg==EX.SrcReg1) or
        (WB.DestReg==EX.SrcReg2) )
            Data Forward;
```

Each register address is represented by 5 bits and the hazard-checking hardware in the forwarding unit can be implemented with fewer than 100 gates.
WAW (write after write)-M tries to write a register before it is written by N. The write ends up being performed in the wrong order, leaving the value written by N rather than the value written by M in the destination. This hazard is not present in our PSM. It is present only in pipelines where write is performed in more than one pipeline stage or in pipelines that allow an instruction to proceed even when a previous instruction is stalled. Both scenarios do not exist in our PSM (writes are done only in WB).
WAR (write after read)-M tries to write a destination before it is read by N, so N incorrectly gets the new value. This hazard is not present in our PSM processor because all reads are early (in ID) and all writes are late (in WB).
RAR (read after read)-This does not cause hazards.
   Control Hazards

Since our PSM has no interrupts, we only need to deal with branches. Again the characteristics of FSM emulation simplify the design. Consider the following example:

| | And r8, r1, r2 |
|---|---|
| | Add r5, r6, r7 |
| | Beq r3, r4, (Next) |
| | Xor r9, r10, r11 |
| | ...... |
| (Next): | Addi r4, r3, 7 |

Xor r3, r7, r6

The branch instruction Beq is executed in the ALU 44 of the EX stage. If r3=r4, the Program Counter is loaded with the target address-the address of the “Next” instruction. The pipeline stages IF 26 and ID 28 will be stalled (doing nothing) until the EX stage 30 gives out the correct next instruction address (see table 1).

TABLE 1
Branch in pipeline

| | | | | | | | | |
|---|---|---|---|---|---|---|---|---|
| Branch(Beq) | IF | ID | EX | WB | | | | |
| Target(Addi) | | Stall | Stall | IF | ID | EX | WB | |
| Target + 1(Xor) | | | | | IF | ID | EX | WB |

Pipeline stall can be reduced by using branch prediction. Many prediction mechanisms are available. Some are described in John L. Hennessy, David A. Patterson “Computer organization and design: the hardware/software interface” San Francisco: Morgan Kaufmann Publishers, 1997. But given the small instruction set of our PSM, we choose a simpler approach: delayed branch as described by Hennessy and Patterson, supra. This technique inserts useful instructions (delay-slot instructions) after the branch instruction so as to save cycles wasted when a branch is taken. Consider the following example where two NOP instructions are inserted by the compiler after branch instruction.

| | And r8, r1, r2 |
|---|---|
| | Add r5, r6, r7 |
| | Beq r3, r4, (Next) |
| | NOP |
| | NOP |
| | Xor r9, r10, r11 |
| | ...... |
| (Next): | Addi r4, r3, 7 |

Xor r3, r7, r6

We can replace the NOP operations by the useful instructions, which may comes from
a. instructions which are in front of the branch (as shown in the following).
b. the branch-taken instructions
c. the branch-not-taken instructions.

Whatever the delay-slot instructions are, they should not change the results regardless of the branch instruction getting executed or not. Because the program in the PSM is simple and predefined, the compiler can easily find two instructions, if they exist, that can replace the NOP operations after branch. One example is shown below.

| | Beq r3, r4, (Next) |
|---|---|
| | And r8, r1, r2 |
| | Add r5, r6, r7 |
| | Xor r9, r10, r11 |
| | ...... |
| (Next): | Addi r4, r3, 7 |

Xor r3, r7, r6

Interfacing with other FSMs/PSMs

A PSM interfaces with the other FSMs or PSMs through registers. There are 32 registers in the PSM of the invention, and each is 16-bits wide. Registers are divided into two groups: general purpose registers and special purpose registers. General-purpose registers are used by the PSM itself and are located in the register file 60 in addition to the pipeline stage registers. They are invisible to the external world. The special purpose registers are the interface registers, and they also are located in register file 60. They can be further divided into input and output registers (FIG. 5). The PSM can read, but not write, the input registers 80. The contents are changed by other FSMs/PSMs. Output registers 82 of a PSM are used to send signals or data to other FSMs/PSMs. They can be read only by other FSMs/PSMs and are written to by the PSM of the invention.

Application Example

We use cell parsing in the port processor as an application example to illustrate the operation of a PSM according to the teachings of the invention. Suppose data arrives at linecard 10 for processing. The line card 10 in FIG. 1 will send fixed-length packets, called cells, through the CSIX interface to the switch 20. Cells are queued in the port processor. Each destination has its own queue, called a virtual output queue (VOQ). The port processor is implemented with many Finite State Machines (FSMs). One such FSM is for header parsing of an incoming cell. We use this as an application example for the PSM to illustrate how the PSM of the invention can perform the function of an FSM and be more flexible in doing so in being able to adapt to protocol changes because of the programmability of the PSM without sacrificing speed and performance enjoyed by the FSM.

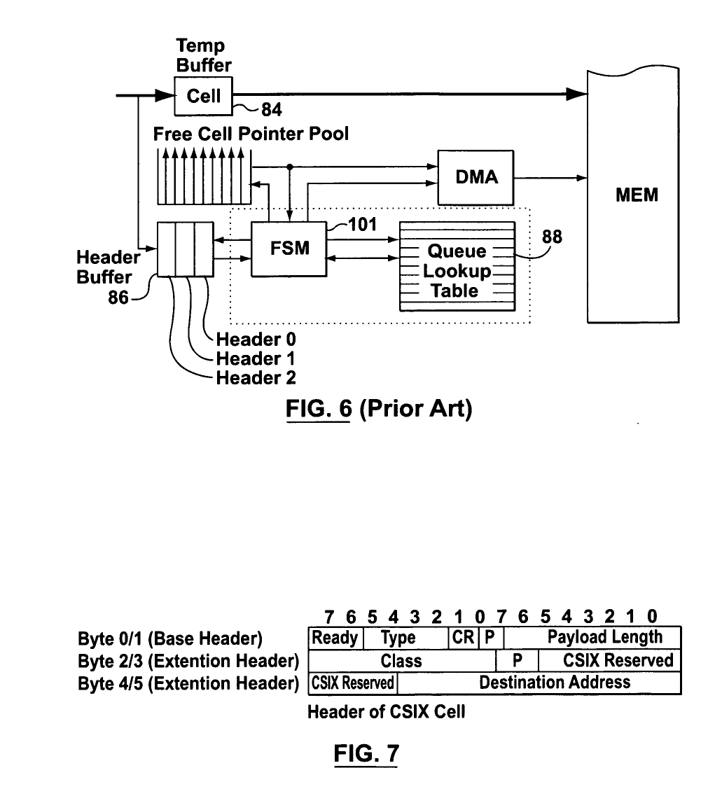

FIG. 6 shows the tasks in header parsing. One task is to check flow-control thresholds to prevent data overrun or underrun. There a re two levels of flow control: VOQ-level and link level. Each level is controlled by two thresholds (high and low mark). When the buffer level exceeds the high mark, flow control is turned on. Flow control will be turned off later when the buffer size drops below the low mark. The high and low marks for the VOQ level are denoted by CloseGateValue and OpenGateValue, and for the link level denoted by MaxTotalCell and MinTotalCell. When a cell arrives, the port processor updates the queue size and checks the high mark thresholds at both levels to see if the VOQ flow control and the link level flow control should be turned on. Similarly when a cell departs, the port processor will check the low-mark thresholds to see if the VOQ and the link level flow control should be turned off. But this is not done in header parsing for incoming cells.

Traditional FSM Approach

FIG. 6 shows the hardware block in a port processor for header parsing. Each incoming cell is stored in a temporary buffer 84. Its CSIX header is stored in a separate header buffer 86. A Queue Lookup Table 88 holds queue pointers and associated flow-control control thresholds for each VOQ. The table is accessed by the combination of the destination address and the priority field.

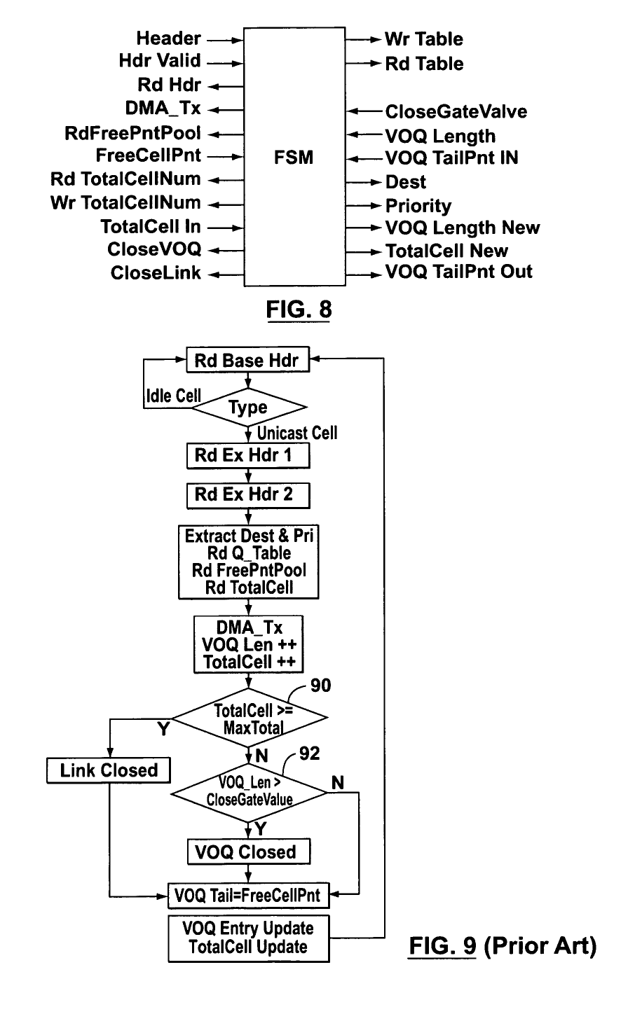

FIG. 6 shows the FSM implementation, and FIG. 8 shows the FSM interface in the prior art. FIG. 8 shows the flow diagram of the prior art process carried out by the FSM where the VOQ Length and the Total_Cell stores the length of the corresponding VOQ and the length of the entire link respectively.

Note that for ingress cell parsing, the FSM only checks the high marks of the two flow control levels in test 90 and 92 of FIG. 8. To simplify the discussion, we do not consider multicast cells which is an optional feature in the CSIX standard. All incoming cells are either idle cells or unicast cells in the example given here. FIG. 7 shows the CSIX header in which two bytes are used for based header and four bytes are used for extension header. For idle cells, only based header is included.

The PSM Approach

To practice the invention, we replace the FSM with a Programmable State Machine having a structure identical or similar to that shown in FIG. 3. The PSM does the same process as the FSM for header parsing, but is more flexible upon encountering protocol changes. We describe the implementation and demonstrate the capability of handing protocol changes of a PSM.

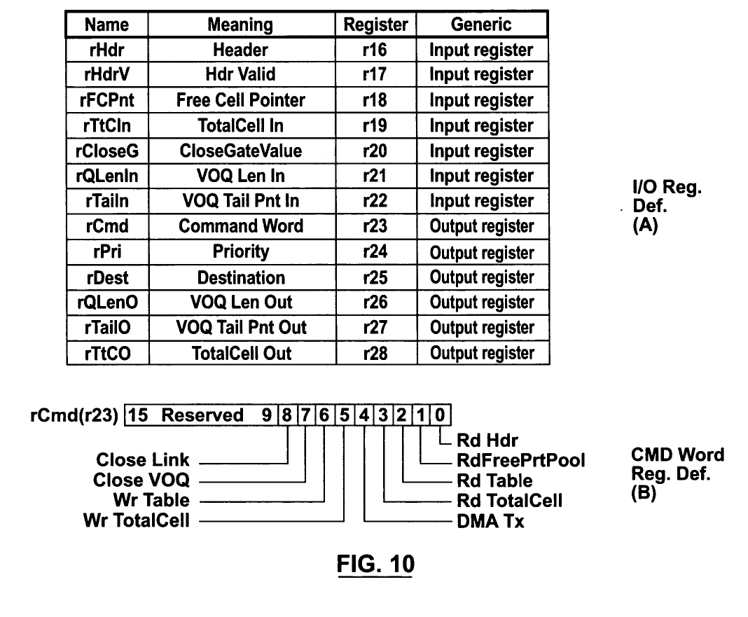

We construct our register file as shown in FIG. 10(A). The first sixteen registers are used as the general purpose registers. The rest are used as input and output registers to interface with other FSMs. For header parsing, only a small portion of the general-purpose registers need be used. The cell's header received from the header buffer 86 in FIG. 6 is stored in rHdr. The last bit of the rHdrV is used to indicate if the header is valid. The remaining bits are not used for this application.

rCmd in FIG. 10 is the command word register. Every bit of the rCmd register represents a control signal. The exact meaning and control signal generated by each bit of rCmd is given in FIG. 10(B). To the PSM of the invention, rCmd is the same as the other output registers and its value is kept valid for only one cycle. The Default value is zero. The external blocks outside the PSM (in the place of FSM 101 in FIG. 6) sample these rCmd bits every cycle. For example, to issue a write command to the queue lookup table 88, an instruction li rCmd, 0×0040 is used. WrTable bit (bit 6 of rCmd) will be asserted for only one cycle.

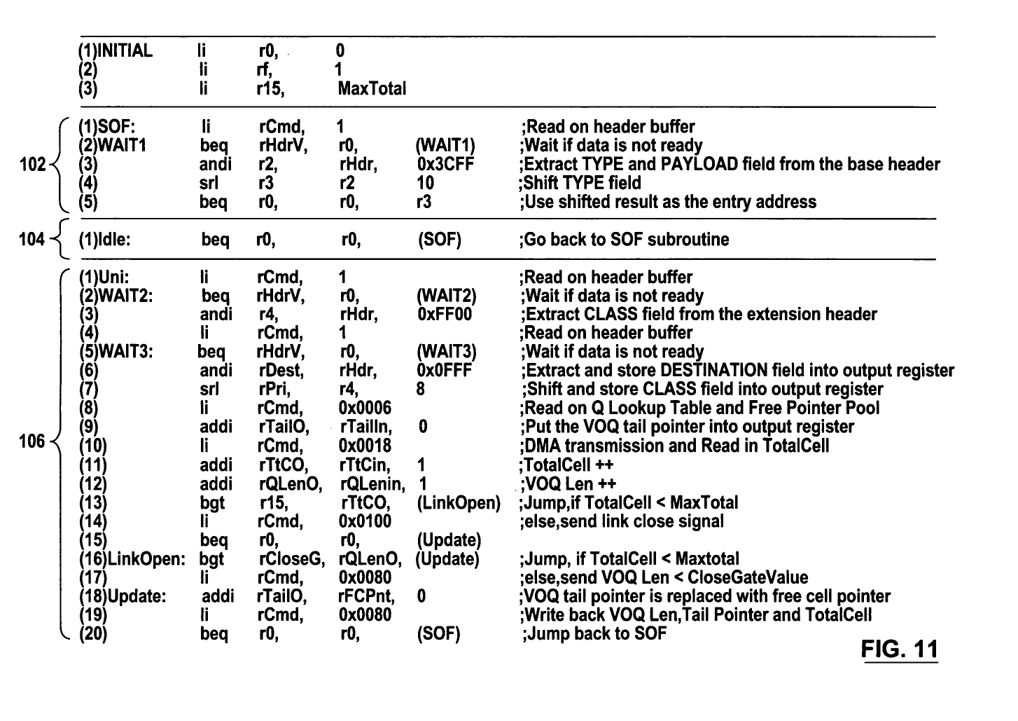

The program to control the PSM to do header parsing is designed in two phases. In the first phase, we produce code to control the PSM to implement the flow diagram in FIG. 9. The resulting program, shown in FIG. 11, has 5 instructions in SOF subroutine 102, 1 instruction in idle subroutine 104, and 20 instructions in unicast subroutine 106. We then use standard compiler techniques to translate it into a more efficient one. These techniques include the following.

1. Minimize the number of branch instructions. This can be done by:
a. replacing the conditional instruction by the other instruction(s) if possible; and
b. replacing the unconditional branch by replicating the whole target subroutine.

2. Reorganize the instruction sequence by replacing the two NOP instructions after the branch with useful instructions.

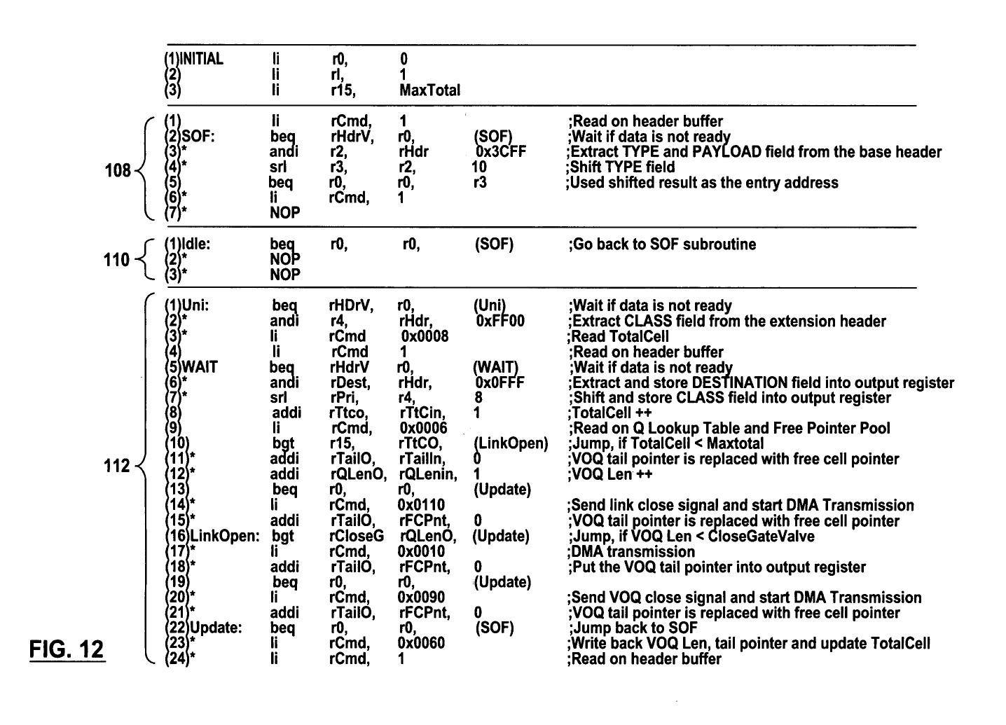

The optimized program (FIG. 12) contains 7 instructions in its SOF subroutine 108, 3 instructions to process the idle cell 110, and 24 instructions in a subroutine 112 to process the unicast cell. Instructions with asterisks are in the delay slot after a branch instruction. They must be executed even if the branch condition of the preceding branch instruction is satisfied. After optimization, nearly all the delay slots of the branch instructions are filled with useful instruction. This allows the PSM to achieve the maximum performance of one instruction per cycle.

1. A programmable state machine comprising:
an instruction fetch stage to fetch instructions;
a instruction decode stage to decode said fetched instructions;
an executive stage to execute fetched instructions;
a write-back stage;
a first pipeline register coupling said instruction fetch stage to said instruction decode stage;
a second pipeline register coupling said instruction decode stage to said executive stage; and
a third pipeline register coupled to receive data output by said executive stage.

2. The programmable state machine of claim 1 wherein said instruction fetch stage comprises:
first means for storing instructions and supplying them at an output;
register means for temporarily storing an instruction output by said first means;
second means for supplying an address to said first means to specify which instruction to output at said output.

3. The programmable state machine of claim 2 wherein said instruction decode stage comprises:
register file means for storing data in multiple registers;
instruction decoder means to decode instructions output by said first means and generate control signals from said decoding operation.

4. The programmable state machine of claim 3 wherein said executive stage comprises:
an arithmetic logic unit means for receiving two operands at first and second inputs and performing whatever arithmetic or logical operation is commanded by an instruction decoded by said instruction decoder means and supplying a result to an output;
forwarding unit means for determining if a read/write hazard exists and generating suitable switching control signals and supplying operands to be processed by said arithmetic logic unit to prevent said read/write hazard;
multiplexer means coupled to said instruction fetch stage and to said second pipeline register and to said forwarding means to receive operands and coupled to said forwarding unit means to receive switching control signals, said multiplexer means for selecting which two operands are supplied to said arithmetic logic unit means in accordance with said switching control signals.

5. The programmable state machine of claim 4 wherein said forwarding unit means determines if said read/write hazard exists by checking to determine if the current instruction operation will change the result stored by a register, and, if so, if the next instruction will use the data stored in said register whose value is changed by execution of the previous instruction, and, if so, generating said switching control signals to cause said multiplexer means to select as operands supplied to said arithmetic logical unit operands supplied by said forwarding unit means.

6. The programmable state machine of claim 5 wherein said write back stage includes means for storing output data from said arithmetic logic unit means and a multiplexer in said executive stage which functions to select the address of a destination register.

7. The programmable state machine of claim 6 wherein said executive stage includes a branch arbitration means coupled to said arithmetic logic unit and said instruction decoder means, said branch arbitration means for receiving information from said instruction decoder means regarding the type of branch proposed when a branch instruction is encountered and for receiving the result of a comparison performed by said arithmetic and logic unit means and determining whether or not to execute said branch.

8. A reduced instruction set pipelined processor and programmed with a single program which causes said processor to emulate the functionality of a finite state machine and having no MEM stage to store the results of instruction execution.

9. The processor of claim 8 including an arithmetic logic unit (ALU) having two operand inputs and a forwarding unit means coupled to said ALU inputs via a plurality of multiplexer, for deciding if a hazard condition exists when executing said program and generating switching control signals for said multiplexers to control operands supplied to said ALU inputs to implement forwarding to eliminate said hazards.

10. The processor of claim 9 wherein said processor includes input and output registers to store input data received from other units and output registers in which data to be output to other circuits is stored such that said processor can interface with other circuits in real time and there is no need to store the results of instruction execution in memory in said processor.

11. The processor of claim 8 including an instruction memory which is only large enough to store the few instructions needed to store said program to implement finite state machine emulation.

12. The processor of claim 8 wherein an instruction set for said processor includes no interrupt instructions.

13. The processor of claim 11 wherein said instruction memory is programmed with a program to emulate a finite state machine function and the program can be changed when the desired finite state machine function to be performed is changed or a protocol changes causes the manner in which said finite state machine function is performed to be changed.

14. The processor of claim 9 wherein said forwarding unit determines if a read after write data hazard condition exists during execution of said by doing two register address comparisons between an executive stage and a writeback stage of said pipelined processor, said data hazard detected using the following logic:
```
if (WB.WrReg==1) then
    if ((WB.DestReg==EX.SrcReg1) or
        (WB.DestReg==EX.SrcReg2) )
            Data Forward
```
Data forward meaning generating control signals to control said multiplexers to eliminate said data hazard, and wherein no other data hazards exist in said processor.

15. The processor of claim 9 wherein said processor has an instruction set which includes no interrupts such that the only control hazards which must be dealt with are branch instruction execution which cause pipeline stall and wherein said program is structured to deal with pipeline stall by insertion of useful instructions called delay-slot instructions after any branch instruction so as to save wasted cycles when a branch is taken.

16. A process carried out in a reduced instruction set pipelined processor having an ALU and a forwarding unit coupled to inputs of said ALU by a plurality of multiplexers, comprising the steps:
executing a program structured to emulate finite state machine functionality;
determining when a read after write data hazard exists and generating control signals which control switching by said multiplexers to control operands supplied to said ALU to eliminate said read after write data hazard.

17. The process of claim 16 further comprising executing useful delay-slot instructions after at least some branch instructions in said program to reduce pipeline stall.
